(19) United States
(12) Patent Application Publication
(10) Pub. No.: US 2005/0272311 A1
(43) Pub. Date: Dec. 8, 2005

(54) Coaxial connector

(76) Inventor: Jung-Tsung Tsao, Shu Lin City (TW)

Correspondence Address: MOLEX INCORPORATED, 2222 WELLINGTON COURT, LISLE, IL, 60532, US

(21) Appl. No.: 11/145,426

(22) Filed: Jun. 3, 2005

(30) Foreign Application Priority Data
Jun. 4, 2004 (TW) 93208885

(51) Int. Cl. H01R 9/05

(52) U.S. Cl. 439/578

(57) ABSTRACT

This invention is a coaxial connector for mating with a mating connector, an inner surrounding surface of an insertion end of the mating connector being provided with an inner groove having an axial surface groove bottom, the coaxial connector comprising a body having a front end having a spring mechanism, a free end of the spring mechanism being formed with an outer flange with an axial outer ring plane. When the spring mechanism is inserted in an insertion space of the mating connector, the outer flange is inlaid in the inner groove and a surface contact is given on the axial outer ring plane of the outer flange to the axial surface groove bottom of the inner groove. Thereby, the coaxial connector of this invention is stably connected to the mating connector with the increased torsion force to ensure that signals are clearly received and transmitted.

### FIELD OF THE INVENTION

The present invention relates to a coaxial connector and particularly to a coaxial connector for improving a torsion force to hold a mating connector.

### BACKGROUND OF THE INVENTION

As is known, an antenna or a coaxial cable of a product for communication is connected through a coaxial connector to a mating connector connected with a communication module in the communication product for achievement of a signal transmission. In different conditions, users are required to adjust the antenna or an angle of the coaxial cable to get a clear signal.

Referring now to FIG. 1, a conventional coaxial connector is aligned with the mating connector, and the coaxial connector comprises a body 1a, an insulative sleeve 2a, and an electrically conductive terminal 3a. The body 1a is a tubular electrically conductive structure, a front end of the body 1a is provided with a slit (not shown) and formed with an elastic fragment 11a, and a free end of each elastic fragment 11a is provided with a convex ring having a cambered surface 111a. A back end of the body 1a may be connected to the antenna (not shown) or the coaxial cable (not shown) or the like. The insulative sleeve 2a is located in the body 1a. The electrically conductive terminal 3a is located in the insulative sleeve 2a. The mating connector comprises a body 4a, an insulative sleeve 5a, and an electrically conductive terminal 6a. The front end of the body 4a has an insertion end 40a formed with an insertion space 41a and an inner groove 42a is formed in an inner surrounding surface of the insertion end 40a. When the elastic fragment 11a at the front end of the body 1a of the coaxial connector is inserted in the insertion space 41a at the insertion end 40a of the body 4a of the mating connector, the outer convex ring 111a is inlaid in the inner groove 42a so that the electrically conductive terminal 3a of the coaxial connector is electrically connected with the electrically conductive terminal 6a of the mating connector.

From the conventional coaxial connector described above, the outer convex ring 111a of the elastic fragment 11a is simply connected through threads with a groove bottom of the inner groove 42a of the insertion end 40a, so no sufficiently stable connection to each other occurs, and at the time of rotation of the antenna or the coaxial cable for adjustment, it is difficult to keep the antenna at a desired angle, thereby resulting in a poor articulation of signal received and further degrading the quality of the signal to be transmitted. Also, when the coaxial connector mates with the mating connector, if the location of the outer convex 111a in the inner groove 42a is undefined, poor conductivity is easily caused by poor contact between the electrically conductive terminal 3a and the electrically conductive terminal 6a.

Indeed, from the description mentioned above, a further improvement is required to the conventional coaxial connector.

### SUMMARY OF THE INVENTION

An object of this invention is to provide a coaxial connector stably connected to the mating connector by increased torsion force so that the signal quality of signals received and transmitted is enhanced.

For the above-mentioned purpose, this invention is mainly to provide a coaxial connector mating with the mating connector, the mating connector having an insertion end, the insertion end being formed with an insertion space, an inner surrounding surface of the insertion end being provided with an inner groove, the inner groove having an axial surface groove bottom, the coaxial connector including the body, which is an electrically conductive structure, preferably in the form of a cylinder, a front end of the body having a spring mechanism, the free end of the spring mechanism being formed with an outer flange, the outer flange having an axial outer ring plane, in which when the spring mechanism is inserted in the insertion space of the mating connector, the outer flange is inlaid in the inner groove and a surface contact is given on the axial outer ring plane of the outer flange to the axial surface groove bottom of the inner groove.

Through the surface contact of the axial outer ring plane of the spring mechanism to the axial surface groove bottom of the insertion end, the coaxial connector of this invention is stably connected to the mating connector, increasing the torsion force.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a sectional view of a conventional coaxial connector and a mating connector;

FIG. 2 is a sectional view of a coaxial connector of this invention connected to an antenna in a first embodiment and a mating connector;

FIG. 3 is a three-dimensional view of the coaxial connector of this invention connected to the antenna in the first embodiment and the mating connector;

FIG. 4 is a three-dimensional view of the coaxial connector of this invention connected to the antenna in the first embodiment and the mating connector;

FIG. 5 is a three-dimensional view of the coaxial connector of this invention connected to the antenna in the first embodiment and the mating connector for use in a recess of a circuit board;

FIG. 6 is a three-dimensional view of the coaxial connector of this invention connected to the antenna in the first embodiment and the mating connector for use in a recess of a circuit board;

FIG. 7 is a three-dimensional view of the coaxial connector of this invention connected to the antenna in the first embodiment and a mating connector for straddle mounting to a circuit board;

FIG. 8 is a three-dimensional view of the coaxial connector of this invention connected to the antenna in the first embodiment and the mating connector for straddle mounting to a circuit board;

FIG. 9 is a plan view of the coaxial connector of this invention in a second embodiment; and

FIG. 10 is a sectional view of the coaxial connector of this invention in a third embodiment and the mating connector for use in a recess of a circuit board.

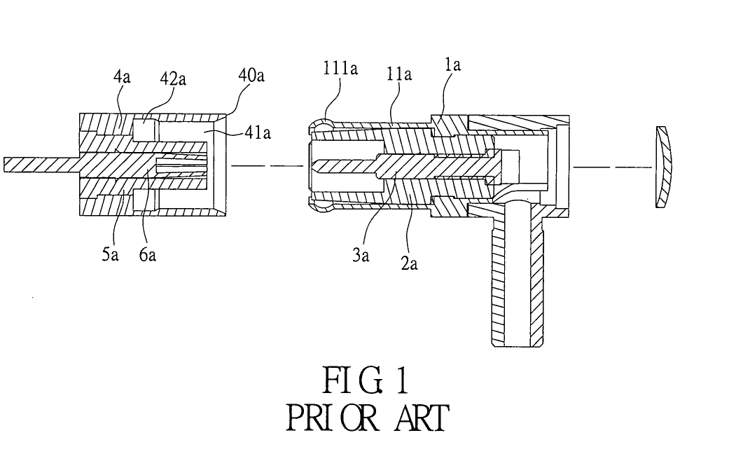

### DETAILED DESCRIPTION OF THE DISCLOSED EMBODIMENTS

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein.

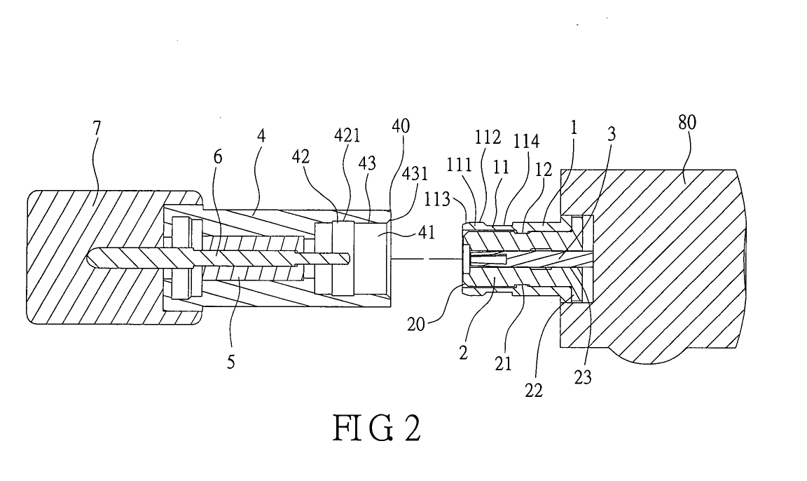

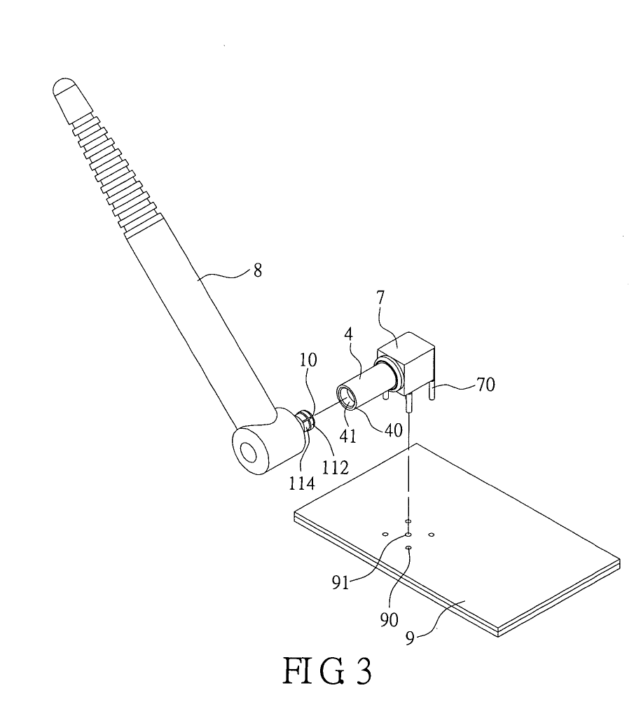

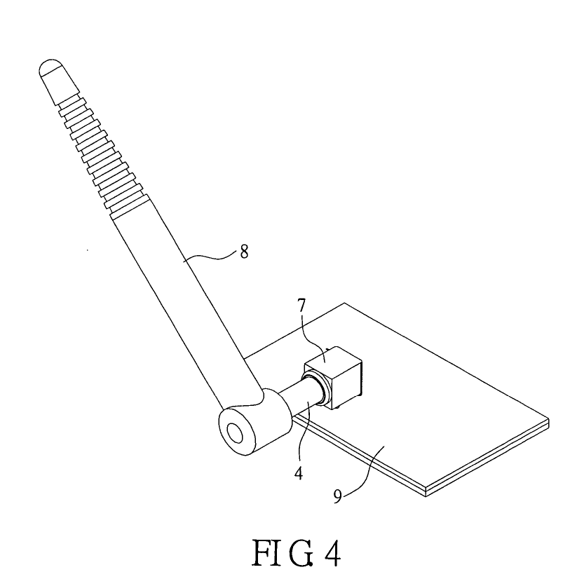

Referring now to FIG. 2 to FIG. 4, a first embodiment is provided according to this invention. This invention is a coaxial connector mating with a mating connector, and the coaxial connector comprises a body 1, an insulative sleeve 2, and an electrically conductive terminal 3. The body is an electrically conductive structure, preferably in the form of a cylinder, the front end of the body 1 having a spring mechanism, the free end of the spring mechanism being formed with an outer flange 111, the outer flange 111 having an axial outer ring plane 112. In the embodiment, the spring mechanism is a front end of the body 1 formed with a slit 10 and then with an elastic fragment 11, a free end of each elastic portion 11 being formed with an outer flange 111, the outer flange 111 of each elastic portion 11 being formed with a chamfer 113, an outer ring plane at a fixed end of each elastic fragment 11 being formed with a hook groove 114. An inner surface of the body 1 is formed with an inner lug 12.

An insulative sleeve 2 is in the form of a pillar, a front end of the insulative sleeve 2 being formed with a chamfer 20, an outer ring plane of the insulative sleeve 2 being formed with an orientation groove 21, a back end of the insulative sleeve 2 being formed with an outside stopper 22. The insulative sleeve 2 pierces through the body 1 from the back end of the body 1, the orientation groove 21 is wedged into the inner lug 12 of the body 1, the outside stopper 22 stops from the back end of the body 1, thereby the insulative sleeve 2 being oriented in the body 1. The insulative sleeve 2 is formed with a hole 23 extending from its front end to back end.

The electrically conductive terminal 3 pierces through the hole 23 for orientation. In the embodiment, the electrically conductive terminal 3 is a female terminal of which the front end is located in the spring mechanism of the body and the back end extends from the insulative sleeve 2. In the embodiment, the body 1 is fixed to the housing 80 of an antenna 8, and the body 1 and the electrically conductive terminal 3 are connected to the coaxial cables (not shown) of the antenna 8, respectively.

In the embodiment, the mating connector is secured to a circuit board 9. The mating connector comprises a body 4, an insulative sleeve 5, an electrically conductive terminal 6, and a fixing base 7. The body 4 is an electrically conductive structure, preferably in the form of a cylinder, the front end of the body 4 having an insertion end 40, the insertion end 40 being formed with an insertion space 41, the inner surrounding surface of the insertion end 40 being provided with an inner groove 42, the inner groove 42 having an axial surface groove bottom 421, a hook block 43 being formed within the insertion space 41 between the inner groove 42 and the insertion end 40, the hook block 43 being formed with a chamfer 431. The insulative sleeve 5 is oriented in the body 4. The electrically conductive terminal 6 is a male terminal oriented in the insulative sleeve 5, the front end of the electrically conductive terminal terminal 6 is located in the insertion space 41, and the back end of the electrically conductive terminal 6 extends beyond the back end of the insulative sleeve 5 and through the back end of the body 4. The back end of the body 4 is fixed to the front end of the fixing base 7, a basal plane of the fixing base 7 is provided with fixing pillars 70, the fixing pillars 70 are inserted into fixing holes 90 of a PCB 9, the fixing base 7 is formed with thru holes (not shown) running through its basal plane to the front end, and the electrically conductive terminal 6 is connected via the thru holes to a pin hole 91 of the PCB 9.

The coaxial connector of the invention mates with the mating connector, and when the spring mechanism at the front end of the body 1 of the coaxial connector is inserted into the insertion space 41 at the insertion end 40 of the body 4 of the mating connector, the advance angle 431 of the insertion end 40 leads the advance angle 113 of the spring mechanism, the hook groove 114 matches with the hook block 43, the outer flange 111 is inlaid in the inner groove 42, and the surface contact is given on the axial outer ring plane 112 of the outer flange 111 to the axial surface groove bottom 421 of the inner groove 42. The electrically conductive terminal 3 (female terminal) of the coaxial connector according to this invention is thereby reliably connected to the electrically conductive terminal 6 (male terminal) of the mating connector. Because of the surface contact of the axial outer ring plane 112 of the spring mechanism to the axial surface groove bottom 421 of the insertion end 40, the connection to each other is highly stable, and when they are joined together, a buckling sound is heard to further confirm that contact of the electrically conductive terminal 3 to the electrically conductive terminal 6 has occurred, thereby assuring reliable conductivity. When the antenna 8 is rotated for adjustment, the torsion force formed from the surface contact increases, the antenna 8 is easily kept at the desired angle in order to assure that a clear signal is received and transmitted.

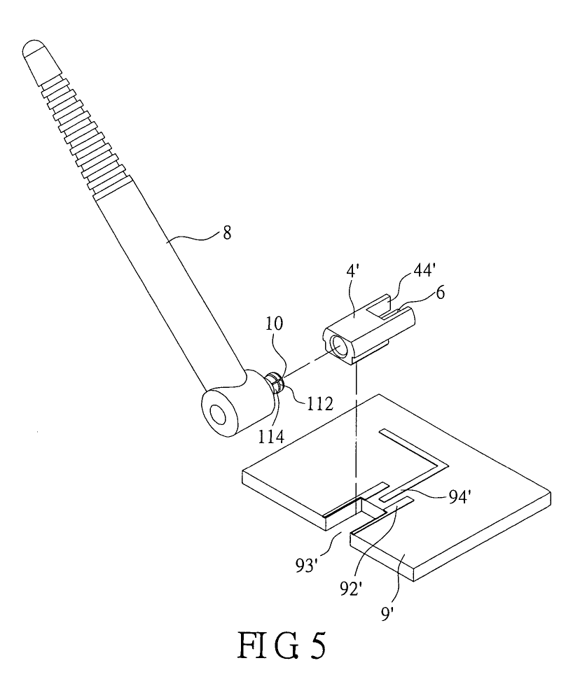

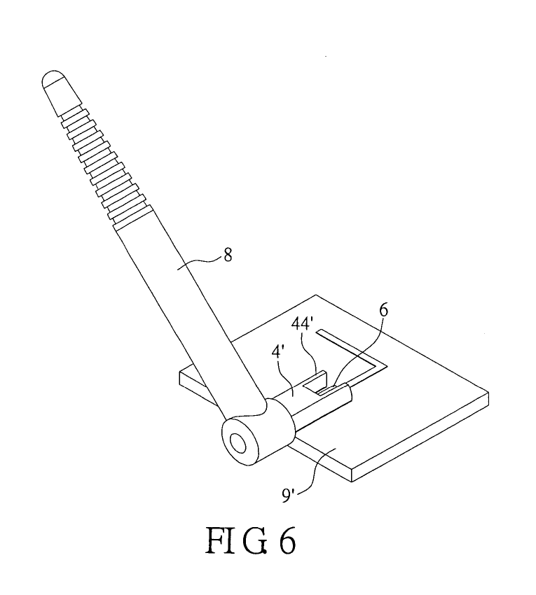

Referring now to FIG. 5 and FIG. 6, the mating connector is located within a recess in the PCB. The mating connector comprises a body 4′, the insulative sleeve (not shown), and the electrically conductive terminal 6. A first-half portion of the back end of the body 4′ is provided with a pillar 44′ located and welded on a pad 92′ of a PCB 9′, and thus a second-half portion of the body 4 is allowed in a recess 93′ on the edge of the PCB 9′. The front end of the body 4′ is identical to the structure of the body 4 described above. The insulative sleeve is fixed in the body 4′. (Refer to the first embodiment.) The electrically conductive terminal 6 is fixed in the insulative sleeve, and the back end of the electrically conductive terminal 6 extends through the back end of the insulative sleeve and is attached to a pad 94′ of the PCB 9′. The height of the connector above the PCB, and therefore the height of the combined PCB-connector structure thereby decreases.

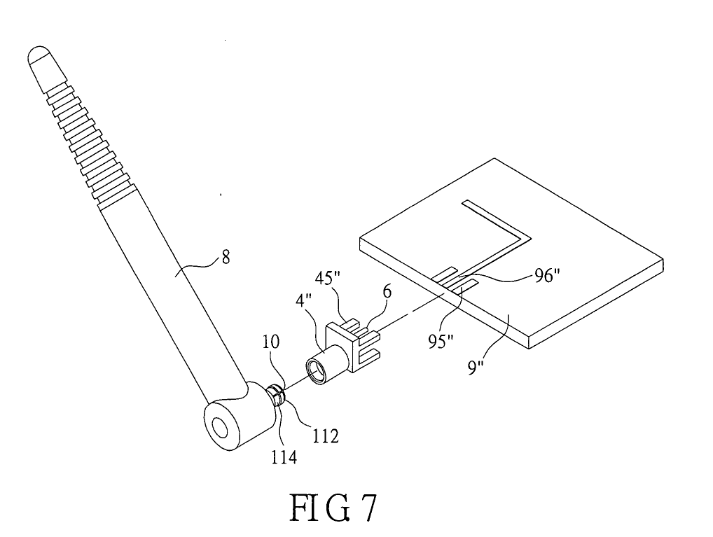

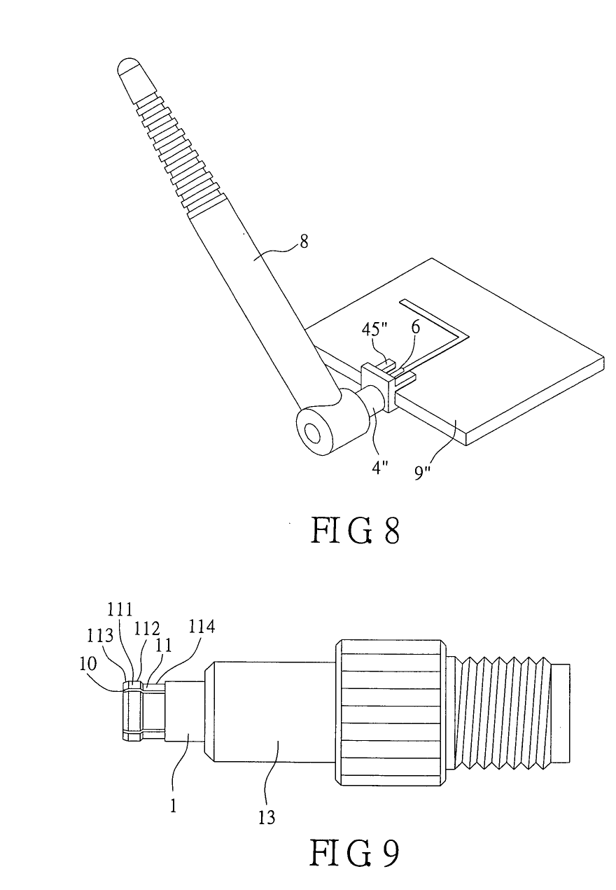

Referring now to FIG. 7 and FIG. 8, the mating connector is that of a straddle mount. The mating connector comprises a body 4″, the insulative sleeve (not shown), and the electrically conductive terminal 6. A second-half portion and a middle portion of the back end of the body 4″ is provided with a fixing pillar 45′ to clip a PCB 9″, the fixing pillar 45′ being attached to a pad 95″ of the PCB 9″. The front end of the body 4″ is same as the structure of the body 4″ (described above). The insulative sleeve is fixed in the body 4″. (Refer to the first embodiment.) The electrically conductive terminal 6 is fixed in the insulative sleeve, and the back end of the electrically conductive terminal 6 pierces through the back end of the insulative sleeve and is attached to a pad 96″ of the PCB 9″. The arrangement of the mating connector is thereby diverse to accommodate the unique requirements of the application using the mating connector.

Referring now to FIG. 9, a second embodiment is provided according to this invention. In the embodiment, an extension part is further included, and one end of the extension part 13 is assembled in the back end of the body 1, thereby the entire electrically conductive structure, preferably in the form of a cylinder, is formed.

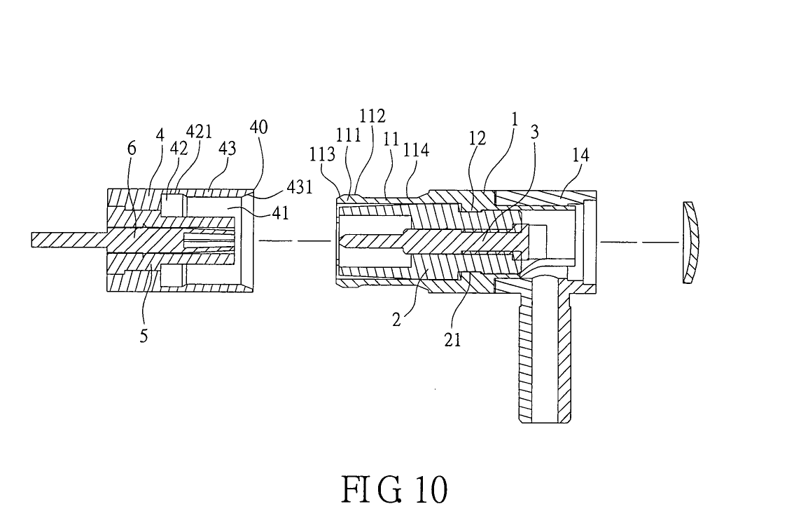

Referring now to FIG. 10, a third embodiment is provided according to this invention. In the embodiment, an extension part 14 is further included, and one end of the extension part 14 is assembled in the back end of the body 1, thereby the entire electrically conductive structure, preferably in the form of a cylinder having a bend therein. Apparent from the second embodiment and the third embodiment, the coaxial connector of this invention may form different entire structures according to the connected object required, such as the antenna, the coaxial cable, or the PCB, and also the connected object of the mating connector may match with the coaxial connector to function as the antenna, the coaxial cable, or the PCB. Furthermore, apparent from the third embodiment, the electrically conductive terminal 3 of the coaxial connector may also be the male terminal, while the electrically conductive terminal 6 of the mating connector 6 may also be the female terminal; however, the electrically conductive terminal 3 in the first embodiment may further be prevented from being misplugged in the conventional mating connector.

For this reason, through the coaxial connector of this invention, the following characteristics are provided:
1. Through the surface contact of the axial outer ring plane of the spring mechanism to the axial surface groove bottom of the insertion end, the coaxial connector of this invention is stably connected to the mating connector, increasing the torsion force, and thus when the coaxial connector of this invention is rotated for adjustment, it is easily kept at the desired angle in the assurance of clear received signal and transmitted signal quality.
2. The body may further be assembled with the extension part to form different types of tubular electrically conductive structure assemblies for matching with different components, such as the antenna, the coaxial cable, or the PCB.
3. The mating connector matching with the coaxial connector may be connected to the PCB to function as the mating connector of on-board type, sinking board type, or batten board type and may also be connected to different components as the coaxial cable and the like.

While preferred embodiments of the present invention are shown and described, it is envisioned that those skilled in the art may devise various modifications of the present invention without departing from the spirit and scope of the appended claims.

1. A coaxial connector for mating with a mating connector, the mating connector having an insertion end formed with an insertion space, an inner surrounding surface of the insertion end being provided with an inner groove having an axial surface groove bottom, the coaxial connector comprising:
a body being an electrically conductive structure, a front end of the body having a spring mechanism, a free end of the spring mechanism being formed with an outer flange having an axial outer ring plane;
wherein when the spring mechanism is inserted in the insertion space of the mating connector, the outer flange is inlaid in the inner groove and a surface contact occurs on the axial outer ring plane of the outer flange to the axial surface groove bottom of the inner groove.

2. The coaxial connector according to claim 1, wherein the spring mechanism is a front end of the body formed with a slit and a plurality of elastic portions, a free end of each elastic portion formed with the outer flange.

3. The coaxial connector according to claim 2, wherein an outer ring plane at a fixed end of each elastic portion of the body is formed with a hook groove, a hook block is formed within the insertion space between the inner groove and the insertion end of the mating connector, and the hook groove engages with the hook block.

4. The coaxial connector according to claim 3, wherein the outer flange of each elastic portion is formed with a chamfer and the hook block of the insertion end of the mating connector is formed with a chamfer.

5. The coaxial connector according to claim 1, comprising an insulative sleeve and an electrically conductive terminal, the insulative sleeve is fixed in the body, the insulative sleeve is formed with a hole for receiving the electrically conductive terminal, and the electrically conductive terminal is received in the hole for orientation.

6. The coaxial connector according to claim 5, wherein an inner surface of the body is formed with an inner lug, a front end of the insulative sleeve is formed with a chamfer, an outer ring plane of the insulative sleeve is formed with an orientation groove, a back end of the insulative sleeve is formed with an outside stopper, the insulative sleeve extends through the body from the back end of the body, the orientation groove is wedged in the inner lug, and the outside stopper stops from the back end of the body.

7. The coaxial connector according to claim 5, wherein the electrically conductive terminal is a female terminal.

8. The coaxial connector according to claim 5, wherein the electrically conductive terminal is a male terminal.

9. The coaxial connector according to claim 1, wherein the body includes an extension part, one end of the extension part is assembled in the back end of the body.

10. The coaxial connector according to claim 1, wherein the body includes an extension part, one end of the extension part is assembled in the back end of the body, the extension part having a bend therein.

11. The coaxial connector according to claim 10, wherein the bend is generally perpendicular.

12. The coaxial connector according to claim 1, wherein the body is generally cylindrical.
